(19) United States
(12) Patent Application Publication
(10) Pub. No.: US 2026/0238147 A1
(43) Pub. Date: Aug. 13, 2026

(54) Motor Control Device, Motor Control Method, and Motor Control System

(71) Applicant: Astemo, Ltd., Chiyoda-ku, Tokyo (JP)

(72) Inventor: Kazuya WATANABE, Hitachinaka-shi, Ibaraki (JP)

(21) Appl. No.: 19/152,050

(22) PCT Filed: Feb. 13, 2024
(86) PCT No.: PCT/JP2024/004740

§ 371 Date: Jul. 30, 2025

(30) Foreign Application Priority Data
Apr. 10, 2023 (JP) 2023-063412

(51) Int. Cl. H02P 21/05; H02P 27/08

(52) U.S. Cl. CPC H02P 21/05; H02P 27/085; H02P 2203/09; H02P 2205/01

(57) ABSTRACT

In a configuration in which an output signal of a current detector of a one-shunt scheme is sampled in a current detection section corresponding to a combination of ON and OFF of a PWM signal to detect phase currents of a motor and the motor is controlled via an inverter based on the detected phase currents, a motor control device, a motor control method, and a motor control system according to the present invention change the length of current detection section based on a voltage of a DC power supply of the inverter. Accordingly, it is possible to easily reduce a change in motor torque due to a change in an inverter voltage.

### TECHNICAL FIELD

The present invention relates to motor control devices, to motor control methods, and to motor control systems.

### BACKGROUND ART

A motor control device disclosed in Patent Document 1 includes PWM (Pulse Width Modulation) signal generating means for generating PWM signals, phases of which deviate from each other, an inverter circuit driven by the PWM signals, a single shunt resistor for detecting motor currents in the phases, current detecting means for detecting, based on an electric current flowing to the shunt resistor, a motor current in a first phase at a first timing and detecting a motor current in a second phase at a second timing, and correcting means for correcting a detection value of the motor current in the first phase with a first offset value and correcting a detection value of the motor current in the second phase with a second offset value.

Furthermore, the motor control device disclosed in Patent Document 1 includes power supply voltage detecting means for detecting a power supply voltage applied to the inverter circuit and offset value changing means for changing the first offset value and the second offset value according to the power supply voltage detected by the power supply voltage detecting means.

### REFERENCE DOCUMENT LIST

### Patent Document

Patent Document 1: JP 2013-121204 A

### SUMMARY OF THE INVENTION

### Problem to be Solved by the Invention

When an offset value is changed according to an inverter voltage in order to prevent motor torque from changing because of an increase or a decrease in a voltage of a DC power supply of an inverter (hereinafter referred to as inverter voltage), since a reduction of the torque change depends on the resolution of current detection, there is a problem in that it is difficult to easily reduce a change in the motor torque due to a change in the inverter voltage.

The present invention has been made in view of such conventional circumstances, and an object of the present invention is to provide a motor control device, a motor control method, and a motor control system that can easily reduce a change in motor torque due to a change in an inverter voltage.

### Means for Solving the Problem

According to one aspect of the present invention, in a configuration in which an output signal of a current detector that detects an electric current flowing between an inverter driven by a PWM signal and a DC power supply of the inverter is sampled in a current detection section corresponding to a combination of ON and OFF of the PWM signal to detect phase currents of a motor and the motor is controlled via the inverter based on the detected phase currents, the length of the current detection section is changed based on a voltage of the DC power supply.

### Effects of the Invention

According to the present invention, it is possible to easily reduce a change in motor torque due to a change in inverter voltage.

### BRIEF DESCRIPTION OF THE DRAWINGS

FIG. 1 is a block diagram illustrating an overall configuration of a motor control system.

FIG. 2 is a block diagram illustrating functional units relating to correction of a current detection section width.

FIG. 3 is a time chart illustrating a current detection section in a one-shunt system.

FIG. 4 is a circuit diagram illustrating a flow of an electric current in a current detection section A illustrated in FIG. 3.

FIG. 5 is a circuit diagram illustrating a flow of an electric current in a current detection section B illustrated in FIG. 3.

FIG. 6 is a time chart illustrating processing for shifting a phase of a PWM signal.

FIG. 7 is a time chart illustrating a difference in an offset amount due to a difference in an inverter voltage.

FIG. 8 is a time chart illustrating correction of the current detection section width corresponding to the inverter voltage.

FIG. 9 is a time chart illustrating a correlation between the current detection section width and the offset amount.

FIG. 10 is a flowchart illustrating limitation processing for the current detection section width.

FIG. 11 is a flowchart illustrating processing for implementing correction according to a condition of rotating speed.

FIG. 12 is a flowchart illustrating processing for giving hysteresis to the implementation and a stop of the correction.

FIG. 13 is a block diagram illustrating a low-pass filter processing function for a signal of the inverter voltage.

FIG. 14 is a block diagram illustrating a low-pass filter processing function for an output signal of a section width correction unit.

FIG. 15 is a time chart illustrating time diffusion processing of section width correction.

FIG. 16 is a diagram illustrating steering torque at the time when the correction of the current detection section width is not implemented.

FIG. 17 is a diagram illustrating steering torque at the time when the correction of the current detection section width is implemented.

### MODE FOR CARRYING OUT THE INVENTION

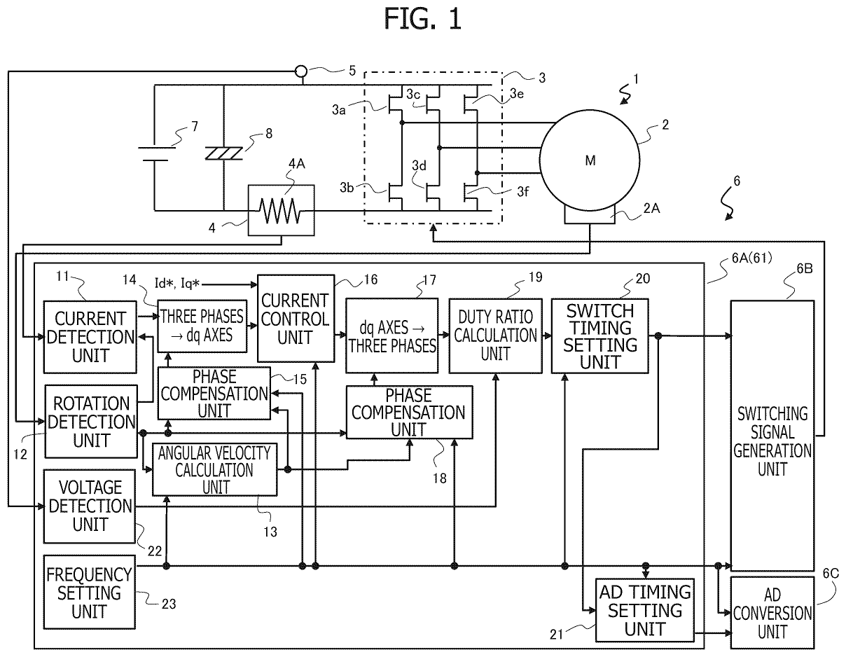

An embodiment of a motor control device, a motor control method, and a motor control system according to the present invention is explained below with reference to the drawings. FIG. 1 is a system diagram illustrating a basic configuration of a motor control system 1 including the motor control device.

Note that motor control system 1 is applied to, for example, control of a motor that generates a steering force in an electric power steering device mounted on a vehicle.

Motor control system 1 includes a motor 2, an inverter circuit 3, a current detector 4, an inverter voltage detector 5, and a motor control device 6.

Motor 2 is a three-phase brushless motor, and includes a three-phase winding wire set consisting of a U-phase coil, a V-phase coil, and a W-phase coil.

Motor 2 includes a rotor angle sensor 2A that detects an angle of a rotor of motor 2.

Inverter circuit 3 is a three-phase bridge circuit consisting of six switching elements 3a to 3f and converts a direct current of a DC power supply 7 into a three-phase alternating current with a PWM signal and performs sine wave driving for motor 2 (in other words, 180 degrees current control).

Note that, as switching elements 3a to 3f, a semiconductor switching element such as an FET (Field effect transistor) is used.

Inverter circuit 3 includes a smoothing capacitor 8 in parallel to DC power supply 7.

Current detector 4 is a device that detects an electric current flowing between inverter circuit 3 and DC power supply 7, that is, a bus current of inverter circuit 3.

Current detector 4 includes a shunt resistor 4A connected in series between inverter circuit 3 and the ground and converts a potential difference between both ends of shunt resistor 4A into a current value to detect an electric current.

That is, motor control system 1 is a system that detects phase currents of phases of motor 2 in a one-shunt scheme. A current detection value by current detector 4 is sampled at timing corresponding to a combination of PWM signals in the phases.

Inverter voltage detector 5 detects a voltage of DC power supply 7 that is a power supply of inverter circuit 3, in other words, an inverter voltage.

Motor control device 6 is an electronic control device including a microcomputer 61 serving as a control unit or a control section.

Microcomputer 61 includes a CPU (Central Processing Unit), a ROM (Read Only Memory), a RAM (Random Access Memory), and the like.

Motor control device 6 includes functional units such as a motor control unit 6A, a switching signal generation unit 6B, and an analog-to-digital conversion unit 6C (hereinafter referred to as AD conversion unit 6C).

Note that motor control unit 6A is a functional unit that microcomputer 61 executes as software.

Motor control unit 6A performs AD conversion for an analog output signal of current detector 4 with AD conversion unit 6C at predetermined timing and acquires output of current detector 4, that is, a detection value of a bus current of inverter circuit 3 as a digital signal.

Then, motor control unit 6A executes feedback control for calculating phase currents from the output of current detector 4, comparing the calculated phase currents and a command current, and performing a correction operation to bring the phase currents closer to the command current. Then, motor control unit 6A implements PWM control for switching elements 3a to 3f of inverter circuit 3.

Switching signal generation unit 6B acquires switch timings THiu*, TLou*, THiv*, TLov*, THiw*, and TLow* generated by motor control unit 6A (specifically, a switch timing setting unit 20 explained below).

Then, switching signal generation unit 6B generates, with a carrier period Tc set as a time reference, a PWM signal (in other words, a gate signal) that is a switching signal for switching elements 3a to 3f of inverter circuit 3 based on switch timings THiu*, TLou*, THiv*, TLov*, THiw*, and TLow*. Then, switching signal generation unit 6B gives the generated PWM signal to switching elements 3a to 3f of inverter circuit 3.

Motor control unit 6A includes functional units such as a current detection unit 11, a rotation angle/rotating speed detection unit 12, an angular velocity calculation unit 13, a three-phase-to-dq-axis conversion unit 14, a first phase compensation unit 15, a current control unit 16, a dq-axis-to-three-phase conversion unit 17, a second phase compensation unit 18, a PWM duty ratio calculation unit 19, a switch timing setting unit 20, an AD timing setting unit 21, an inverter voltage detection unit 22, and a carrier frequency setting unit 23.

Current detection unit 11 reproduces, based on a motor rotating speed ω and a bus current IDC of inverter circuit 3, three-phase currents Iu, Iv, and Iw flowing to motor 2.

Note that current detection unit 11 sets, from a combination of ON and OFF of a PWM signal, a current detection section in which a phase current having a maximum voltage phase can be detected by current detector 4 and a current detection section in which a phase current having a minimum voltage phase can be detected by current detector 4 and calculates a phase current having an intermediate voltage phase from a detection value of the phase current having the maximum voltage phase and a detection value of the phase current having the minimum voltage phase.

Rotation angle/rotating speed detection unit 12 acquires output of rotor angle sensor 2A, outputs a signal of a motor electric angle θe0, and further calculates the motor rotating speed ω based on the difference between the last value and the current value of the motor electric angle θe0, and outputs a signal of the motor rotating speed ω.

Angular velocity calculation unit 13 calculates electric angular velocity we based on the difference between the last value and the current value of the motor electric angle θe0 and outputs a signal of the electric angular velocity de.

First phase compensation unit 15 acquires signals of the motor electric angle θe0, the electric angular velocity we, and carrier period Tc set by carrier frequency setting unit 23. Then, first phase compensation unit 15 considers time deviation between current detection timing and timing when rotation angle detection was performed and outputs a signal of a motor electric angle θe1 obtained by correcting the motor electric angle θe0 as if the rotation angle detection was performed at the current detection timing.

Three-phase-to-dq-axis conversion unit 14 performs, based on three-phase currents Iu, Iv, and Iw and the motor electric angle θe1, coordinate conversion for vector control for replacing a three-phase AC current with a two-axis direct current, and outputs a signal of a magnetic flux (d axis) electric current Id and a signal of a torque (q axis) current Iq.

Current control unit 16 outputs a d-axis command voltage Vd* and a q-axis command voltage Vq* based on the command currents Id* and Iq*, the actual currents Id and Iq, and the electric angular velocity we, such that actual currents Id and Iq calculated by three-phase-to-dq-axis conversion unit 14 follow a d-axis command current Id* and a q-axis command current Iq* given from the outside.

Second phase compensation unit 18 acquires signals of the motor electric angle θe0, the electric angular velocity we, and carrier period Tc, considers time deviation between voltage reflection timing and timing when rotation angle detection was performed, and outputs a signal of the motor electric angle θe2 obtained by correcting the motor electric angle θe0 as if the rotation angle detection was performed at the voltage reflection timing.

dq-axis-to-three-phase conversion unit 17 performs, based on the d axis command voltage Vd* and the q axis command voltage Vq* and the motor electric angle θe2, coordinate conversion for converting two-axis voltage commands Vd* and Vq* for vector control into three-phase voltage commands Vu*, Vv*, and Vw*, and outputs signals of the three-phase voltage commands Vu*, Vv*, and Vw*.

Inverter voltage detection unit 22 acquires output of inverter voltage detector 5, and detects an inverter voltage VINV, that is, a voltage of DC power supply 7 that is the power supply of inverter circuit 3.

PWM duty ratio calculation unit 19 calculates three-phase command duty ratios DUu*, DUv*, and DUw* based on the three-phase voltage commands Vu*, Vv*, and Vw* and a ratio of inverter voltage VINV.

Switch timing setting unit 20 compares the three-phase command duties ratios DUu*, VUv*, and DUw* and the carrier period Tc, and outputs switch timings THiu*, TLou*, THiv*, TLov*, THiw*, and TLow* for respective switching elements 3a to 3f of inverter circuit 3.

Switching signal generation unit 6B generates, with the carrier period Td set as a time reference, and based on switch timings THiu*, TLou*, THiv*, TLov*, THiw*, and TLow*, PWM signals that are switching signals for respective switching elements 3a to 3f of inverter circuit 3, and gives the generated PWM signals to switching elements 3a to 3f of inverter circuit 3.

AD timing setting unit 21 sets, based on switch timings THiu*, TLou*, THiv*, TLov*, THiw*, and TLow*, AD timings TADI, TADθ, and TADV for performing AD conversion and acquiring the bus current IDC, the motor electric angle θe0, and inverter voltage VINV of inverter circuit 3.

AD conversion unit 6C implements, with a signal synchronized with a control period generated based on carrier period Tc as a reference, AD conversion, that is, sampling of the bus current IDC, the motor electric angle θe0, and inverter voltage VINV, based on the AD timings TADI, TADθ, and TADV.

Motor control unit 6A calculates switch timings THiu*, TLou*, THiv*, TLov*, THiw*, and TLow* for respective switching elements 3a to 3f based on the bus current IDC, the motor electric angle θe0, and inverter voltage VINV sampled by AD conversion unit 6C.

Carrier frequency setting unit 23 selects, based on a control condition or the like of motor 2, one of a plurality of kinds of carrier periods Tc set in advance, and sets a control period Tcc that is an integer multiple of carrier period Tc.

Then, carrier frequency setting unit 23 outputs signals of carrier period Tc and the control period Tcc to angular velocity calculation unit 13, first phase compensation unit 15, current control unit 16, second phase compensation unit 18, switch timing setting unit 20, switching signal generation unit 6B, AD timing setting unit 21, and AD conversion unit 6C.

Note that the angular velocity we calculated by angular velocity calculation unit 13 may vibrate, if a detection error is present in the motor electric angle θe0 detected by rotor angle sensor 2A.

Thus, angular velocity calculation unit 13 calculates the angular velocity we by performing processing for removing a vibration component of the angular velocity we with a digital filter.

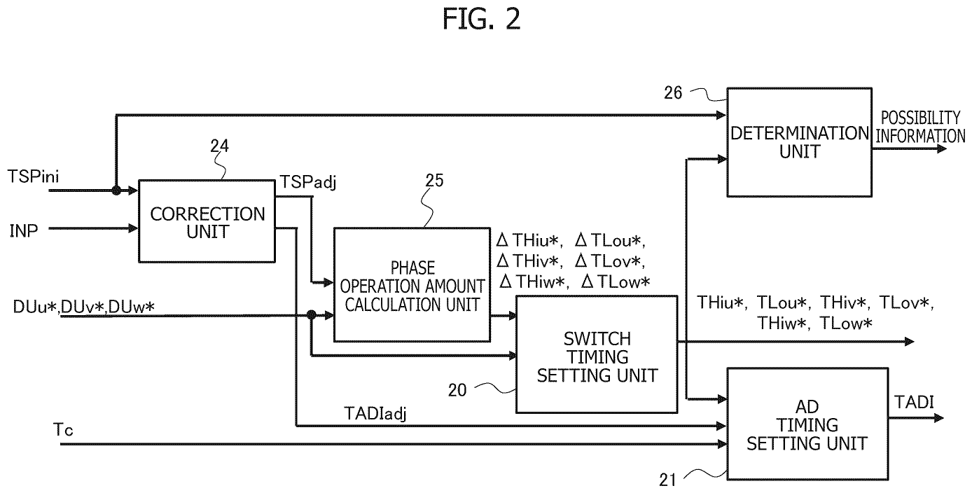

FIG. 2 is a block diagram illustrating characteristic components of motor control unit 6A of motor control system 1 in the present embodiment.

Motor control unit 6A of motor control system 1 includes, in addition to the basic components illustrated in FIG. 1, a current detection section width correction unit 24, a PWM phase operation amount calculation unit 25, and a current detection possibility determination unit 26.

Here, current detection section width correction unit 24 is a functional unit that corrects, according to inverter voltage VINV, the width of a current detection section (in other words, the length of time of the current detection section) that is a section in which phase currents of motor 2 are detected by current detection unit 11.

PWM phase operation amount calculation unit 25 is a functional unit that, in order to ensure the width of the current detection section set by current detection section width correction unit 24, calculates an amount for shifting phases of PWM signals in phases from one to another.

Furthermore, current detection possibility determination unit 26 determines, according to whether the width of the current detection section is set to a minimum required width, whether current detection is possible and outputs information concerning current detection possibility to current detection unit 11 and current control unit 16.

Note that the current detection section is a section in which an electric current equivalent to a phase current of one phase among three phases flows to shunt resistor 4A and is a section from timing when a combination of ON and OFF of a PWM signal, which is a switching signal of switching elements 3a to 3f, is switched until an output signal of current detector 4 is AD-converted and sampled.

The width of the current detection section is set to be equal to or longer than a reference time set by considering a delay time of switching elements 3a to 3f, a stabilization time of a circuit, an AD conversion time, or the like. A point in time when at least a reference time or more has elapsed from the timing when the combination of ON and OFF of the PWM is switched is set as AD conversion timing, that is, an end period of the current detection section.

In the following explanation, the functions of current detection section width correction unit 24, PWM phase operation amount calculation unit 25, and current detection possibility determination unit 26 are explained in detail.

Current detection section width correction unit 24 acquires a reference value TSPini that is a reference length of the current detection section width and an input value INP including inverter voltage VINV and calculates and outputs a current detection section width TSPadj obtained by correcting reference value TSPini according to inverter voltage VINV and a current detection timing correction value TADIadj.

Note that the correction of the current detection section corresponding to inverter voltage VINV implemented by current detection section width correction unit 24 is processing for fixing, even if inverter voltage VINV changes, an offset occurring in an electric current detected in current detection section by current detector 4 that is a current sensor of the one-shunt system.

Current detection section width correction unit 24 increases current detection section width TSPadj to be longer as inverter voltage VINV is lower.

In order to ensure current detection section width TSPadj, PWM phase operation amount calculation unit 25 calculates switch timing correction values ΔTHiu*, ΔTLou*, ΔTHiv*, ΔTLov*, ΔTHiw*, and ΔTLow* based on current detection section width TSPadj and three-phase command duty ratios DUu*, DUv*, and DUw* and outputs switch timing correction values ΔTHiu*, ΔTLou*, ΔTHiv*, ΔTLov*, ΔTHiw*, and ΔTLow*.

That is, when current detection section width TSPadj cannot be ensured when the processing for shifting the phases of the PWM signals in the phases from one to another is not implemented, PWM phase operation amount calculation unit 25 sets a shift amount of the phases of the PWM signals such that current detection section width TSPadj is ensured by shifting the phases of the PWM signals from one to another.

Here, in the correction of current detection section width TSPadj corresponding to inverter voltage VINV, since current detection section width TSPadj is set longer as inverter voltage VINV is lower, the shift amount of the phases in the processing for shifting the phases of the PWM signals from one to another in order to ensure current detection section width TSPadj is set to a larger value as inverter voltage VINV is lower.

Therefore, when three-phase command duty ratios DUu*, DUv*, and DUw* are the same, deviation of the phases of the PWM signals being set larger as inverter voltage VINV is lower is equivalent to implementation of the processing for setting current detection section width TSPadj longer as inverter voltage VINV is lower.

Then, switch timing setting unit 20 calculates and outputs switch timings THiu*, TLou*, THiv*, TLov*, THiw*, and TLow* based on three-phase command duty ratios DUu*, DUv*, and DUw*, carrier period Tc, and switch timing correction values ΔTHiu*, ΔTLou*, ΔTHiv*, ΔTLov*, ΔTHiw*, and ΔTLow*.

That is, switch timing setting unit 20 corrects, based on switch timing correction values ΔTHiu*, ΔTLou*, ΔTHiv*, ΔTLov*, ΔTHiw*, and ΔTLow*, basic switch timings THiu*, TLou*, THiv*, TLov*, THiw*, and TLow* calculated based on three-phase command duty ratios DUu*, DUv*, and DUw* and carrier period Tc.

AD timing setting unit 21 calculates current detection timing TADI based on switch timings THiu*, TLou*, THiv*, TLov*, THiw*, and TLow*, current detection timing correction value TADIadj, and carrier period Tc and outputs a signal of current detection timing TADI to AD conversion unit 6C.

Current detection possibility determination unit 26 determines, based on reference value TSPini of the current detection section width and switch timings THiu*, TLou*, THiv*, TLov*, THiw*, and TLow*, whether phase currents can be detected by current detector 4 and outputs a signal indicating a determination result.

In the following explanation, detection processing for phase currents of motor 2 in motor control system 1 is explained in detail below.

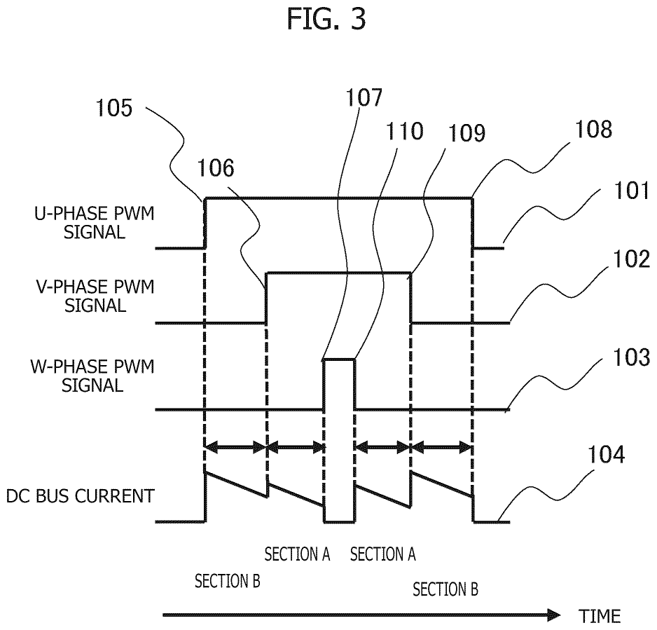

FIG. 3 to FIG. 5 are diagrams for explaining detection processing for a basic bus current.

FIG. 3 illustrates an aspect of a correlation between PWM signals 101, 102, and 103 in a U phase, a V phase, and a W phase and a bus current 104 detected by current detector 4.

Note that PWM signals 101, 102, and 103 are the PWM signals given to switching elements of upper arms in the phases and the switching elements of the upper arms and switching elements of lower arms are complementarily driven.

In FIG. 3, PWM signal 101 in the U phase is turned on at U-phase ON timing 105 and turned off at U-phase OFF timing 108.

PWM signal 102 in the V phase is turned on at V-phase ON timing 106 and is turned off at V-phase OFF timing 109.

PWM signal 103 in the W phase is turned on at W-phase ON timing 107 and is turned off at W-phase OFF timing 110.

Here, ON/OFF timings of PWM signals 101, 102, and 103 are in the order of U-phase ON timing 105, V-phase ON timing 106, W-phase ON timing 107, W-phase OFF timing 110, V-phase Off timing 109, and U-phase OFF timing 108 in time series.

In FIG. 3, an ON period of PWM signal 101 in the U phase is the longest, an ON period of the PWM signal 103 in the W phase is the shortest, an ON period of the PWM signal 102 in the V phase is intermediate and the U phase is a maximum voltage phase, the W phase is a minimum voltage phase, and the V phase is an intermediate voltage phase.

Bus current 104 detected by current detector 4 is zero when all of U-phase PWM signal 101, V-phase PWM signal 102, and W-phase PWM signal 103 are ON, that is, in the ON period of the PWM signal in the W phase.

Bus current 104 detected by current detector 4 is zero when all of U-phase PWM signal 101, V-phase PWM signal 102, and W-phase PWM signal 103 are OFF, that is, before U-phase ON timing 105 and after U-phase OFF timing 108.

On the other hand, a current detection section A in which U-phase PWM signal 101 is ON, V-phase PWM signal 102 is ON, and W-phase PWM signal 103 is OFF is a first current detection section that is a section in which a W-phase current Iw flows to shunt resistor 4A of current detector 4.

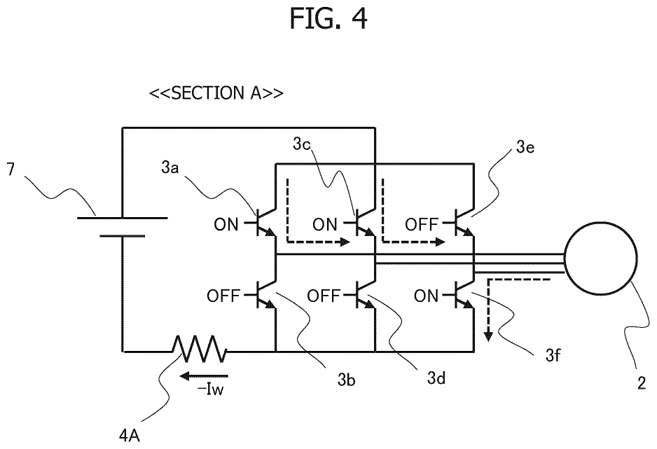

FIG. 4 illustrates ON and OFF states of switching elements 3a to 3f in current detection section A.

In current detection section A, switching element 3a of the upper arm in the U phase is ON, switching element 3b of the lower arm in the U phase is OFF, switching element 3c of the upper arm in the V phase is ON, switching element 3d of the lower arm in the V phase is OFF, switching element 3e of the upper arm in the W phase is OFF, and switching element 3f of the lower arm in the W phase is ON.

For this reason, in current detection section A, an electric current flowing from switching element 3a of the upper arm in the U phase to the U phase of motor 2 and an electric current flowing from switching element 3c of the upper arm in the V phase to the V phase of motor 2 merge at a connection portion of a star connection and an electric current flows to shunt resistor 4A of current detector 4 through the W phase of motor 2 and switching element 3f of the lower arm in the W phase.

Therefore, bus current 104 detected by current detector 4 in current detection section A changes to a negative W-phase current Iw. It is possible to detect phase current Iw in the W phase, which is the minimum voltage phase, by detecting an electric current flowing to shunt resistor 4A in current detection section A.

Note that, in the present embodiment, in a star-connected three-phase winding wire of motor 2, an electric current flowing from a connecting portion, in which the three-phase winding wire is connected, to the winding wire is referred to as negative current and an electric current flowing from the winding wire to the connecting portion is referred to as positive current.

A current detection section B in which U-phase PWM signal 101 is ON, V-phase PWM signal 102 is OFF, and W-phase PWM signal 103 is OFF is a section in which a U-phase current Iu flows to shunt resistor 4A of current detector 4.

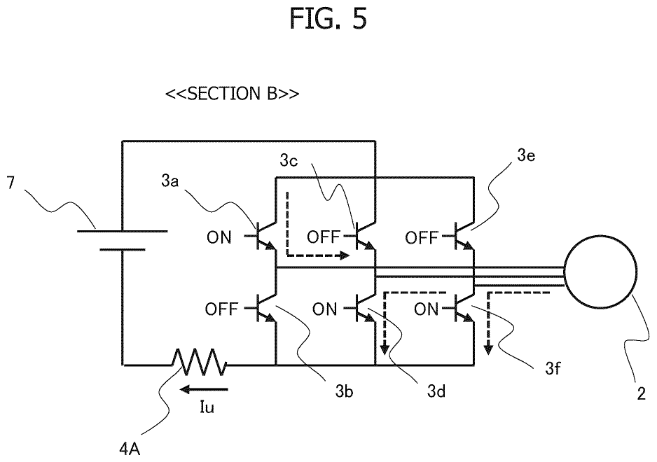

FIG. 5 illustrates ON and OFF states of switching elements 3a to 3f in current detection section B.

In section B, switching element 3a of the upper arm in the U phase is ON, switching element 3b of the lower arm in the U phase is OFF, switching element 3c of the upper arm in the V phase is OFF, switching element 3d of the lower arm in the V phase is ON, switching element 3e of the upper arm in the W phase is OFF, and switching element 3f of the lower arm in the W phase is ON.

For this reason, in current detection section B, an electric current flowing from switching element 3a of the upper arm in the U phase to the U phase of motor 2 is divided into the V phase and the W phase and flows from the connecting portion of the star connection.

Then, the electric current flowing to the V phase flows through switching element 3d of the lower arm in the V phase, the electric current flowing to the W phase flows through switching element 3f of the lower arm in the W phase, and the electric current flowing to the V phase and the electric current flowing to the W phase merge and flow to shunt resistor 4A of current detector 4.

Here, since a total of the V-phase current and the W-phase current is the U-phase current, an electric current detected by current detector 4 in current detection section B, which is a second current detection section, is the positive U-phase current Iu. By detecting an electric current flowing to shunt resistor 4A in current detection section B, it is possible to detect phase current Iu in the U phase, which is the maximum voltage phase.

Furthermore, three-phase currents Iu, Iv, and Iw satisfy a relational equation “Iu+Iv+Iw=0”. For this reason, if W-phase current Iw is detected in current detection section A and U-phase current Iu is detected in current detection section B, V-phase current Iv is calculated by the relational equation “Iu+Iv+Iw=0”.

That is, if phase currents are detected by current detector 4 for two phases among three phases, a phase current in the remaining one phase can be calculated without being detected by current detector 4.

As a combination pattern of ON and OFF of PWM signals 101, 102, and 103, phase currents in two phases of which can be detected by current detector 4 in one period of PWM, there are five patterns explained below in addition to the pattern illustrated in FIG. 3 according to combinations of a maximum voltage phase, a minimum voltage phase, and an intermediate voltage phase.

When the maximum voltage phase is the U phase and the minimum voltage phase is the V phase, negative V-phase current Iv can be detected by current detector 4 in a section in which U-phase PWM signal 101 is ON, V-phase PWM signal 102 is OFF, and W-phase PWM signal 103 is ON and the positive U-phase current Iu can be detected by current detector 4 in a section in which U-phase PWM signal 101 is ON, V-phase PWM signal 102 is OFF, and W-phase PWM signal 103 is OFF.

When the maximum voltage phase is the V phase and the minimum voltage phase is the W phase, the negative W-phase current Iw can be detected by current detector 4 in a section in which U-phase PWM signal 101 is ON, V-phase PWM signal 102 is ON, and W-phase PWM signal 103 is OFF and positive V-phase current Iv can be detected by current detector 4 in a section in which U-phase PWM signal 101 is OFF, V-phase PWM signal 102 is ON, and W-phase PWM signal 103 is OFF.

When the maximum voltage phase is the V phase and the minimum voltage phase is the U phase, the negative U-phase current Iu can be detected by current detector 4 in a section in which U-phase PWM signal 101 is OFF, V-phase PWM signal 102 is ON, and W-phase PWM signal 103 is ON and positive V-phase current Iv can be detected by current detector 4 in a section in which U-phase PWM signal 101 is OFF, V-phase PWM signal 102 is ON, and W-phase PWM signal 103 is OFF.

When the maximum voltage phase is the W phase and the minimum voltage phase is the U phase, the negative U-phase current Iu can be detected by current detector 4 in a section in which U-phase PWM signal 101 is OFF, V-phase PWM signal 102 is ON, and W-phase PWM signal 103 is ON and positive W-phase current Iw can be detected by current detector 4 in a section in which U-phase PWM signal 101 is OFF, V-phase PWM signal 102 is OFF, and W-phase PWM signal 103 is ON.

Furthermore, when the maximum voltage phase is the W phase and the minimum voltage phase is the V phase, negative V-phase current Iv can be detected by current detector 4 in a section in which U-phase PWM signal 101 is ON, V-phase PWM signal 102 is OFF, and W-phase PWM signal 103 is ON and positive W-phase current Iw can be detected by current detector 4 in a section in which U-phase PWM signal 101 is OFF, V-phase PWM signal 102 is OFF, and W-phase PWM signal 103 is ON.

As explained above, a section in which phase currents can be detected by current detector 4 is decided according to a combination of ON and OFF of PWM signals 101, 102, and 103. However, in some cases, the length of a section in which the combination of ON and OFF of PWM signals 101, 102, and 103 is retained changes according to three-phase command duty ratios DUu*, DUv*, and DUw* and necessary length of the current detection section cannot be ensured.

For that reason, PWM phase operation amount calculation unit 25 of motor control unit 6A ensures the necessary length of the current detection section (in other words, a current detection section width) by shifting the phases of the PWM signals from one to another while retaining pulse widths corresponding to three-phase command duty ratios DUu*, DUv*, and DUw*.

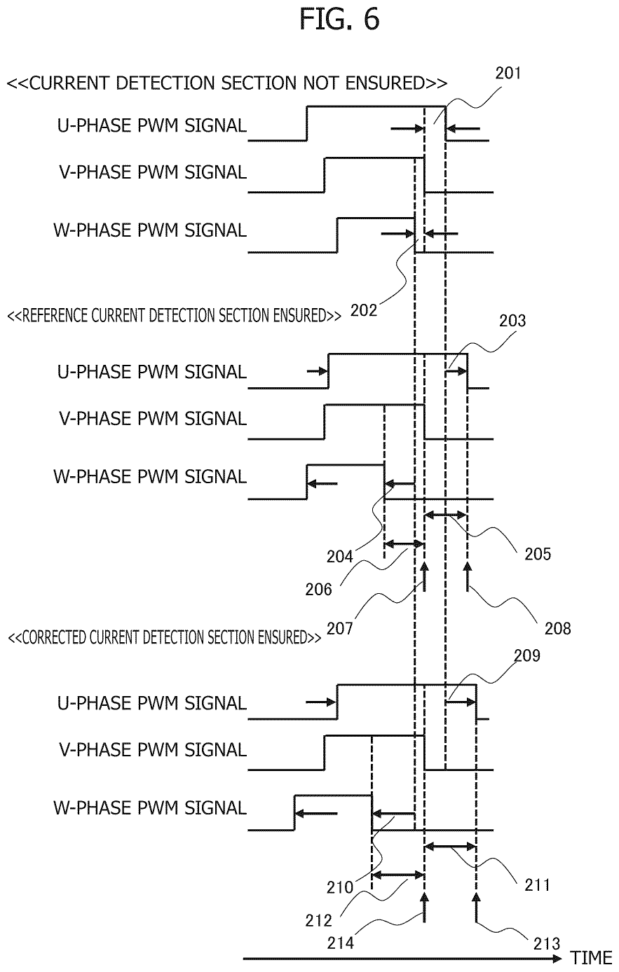

FIG. 6 is a time chart exemplifying processing for shifting the phases of the PWM signals from one to another. A case in which phase current Iu in the U phase, which is the maximum voltage phase, and phase current Iw in the W phase, which is the minimum voltage phase, are detected by current detector 4 is exemplified.

An upper part of FIG. 6 illustrates the PWM signals in a state in which the processing for shifting the phases of the PWM signals from one to another is not implemented.

A middle part of FIG. 6 illustrates the PWM signals in a state in which the processing for shifting the phases of the PWM signals from one to another is implemented in order to ensure reference value TSPini of the current detection section width.

Furthermore, a lower part of FIG. 6 illustrates the PWM signals in a state in which the processing for shifting the phases of the PWM signals from one to another is implemented in order to ensure current detection section width TSPadj (TSPadj>TSPini) obtained by correcting reference value TSPini of the current detection section width according to inverter voltage VINV.

In the upper part of FIG. 6, a U-phase current detection section width 201 is the difference between U-phase OFF timing and V-phase OFF timing and a W-phase current detection section width 202 is the difference between W-phase OFF timing and V-phase OFF timing.

U-phase current detection section width 201 and W-phase current detection section width 202 change according to three-phase command duty ratios DUu*, DUv*, and DUw*. However, a section width that is at least necessary for current detection is decided as reference value TSPini in advance.

Reference value TSPini of the current detection section width is a time determined considering a delay time of switching elements 3a to 3f, a dead time for not simultaneously turning on a switching element of an upper arm and a switching element of a lower arm, a stabilization time of a circuit that amplifies and detects a voltage drop that occurs when an electric current flows to shunt resistor 4A, an AD conversion time necessary when sampling the amplified voltage drop with AD conversion unit 6C, and the like.

For this reason, if the current detection section width is shorter than reference value TSPini, motor control unit 6A cannot acquire a stable current detection value and cannot use the current detection value for motor control.

Therefore, in current detection, it is necessary to ensure a current detection section width equal to or longer than current detection section width reference value TSPini and sample output of current detector 4 as a phase current detection value after at least the current detection section reference value TSPini elapses from a start point of a current detection section.

When U-phase current detection section width 201 and W-phase current detection section width 202 in the state in which the processing for shifting the phases is not implemented are shorter than reference value TSPini as illustrated in the upper part of FIG. 6, motor control unit 6A implements the processing for shifting the phases of the PWM signals from one to another as illustrated in the middle part of FIG. 6 in order to ensure the current detection section of reference value TSPini.

Specifically, PWM phase operation amount calculation unit 25 of motor control unit 6A calculates, as a U-phase PWM shift amount 203 (in other words, a shift amount of a U-phase PWM signal), a value obtained by subtracting U-phase current detection section width 201 from reference value TSPini, that is, a shortage of a current detection section width and, similarly, calculates, as a W-phase PWM shift amount 204 (in other words, a shift amount of a W-phase PWM signal), a value obtained by subtracting W-phase current detection section width 202 from reference value TSPini.

Then, switch timing setting unit 20 of motor control unit 6A implements shift processing for applying U-phase PWM shift amount 203 to U-phase ON timing and U-phase OFF timing and delaying a phase of the U-phase PWM signal by U-phase PWM shift amount 203 and, similarly, implements shift processing for applying W-phase PWM shift amount 204 to W-phase ON timing and W-phase OFF timing and advancing a phase of the W-phase PWM signal by W-phase PWM shift amount 204.

Switch timing setting unit 20 of motor control unit 6A equalizes, with the shift processing for the PWM signals, a U-phase current detection section width 205 after the shift processing and a W-phase current detection section width 206 after the shift processing with reference value TSPini.

Then, AD timing setting unit 21 of motor control unit 6A sets a U-phase current detection timing 208 as an end point of U-phase current detection section width 205 after the shift processing (in other words, U-phase OFF timing after the shift processing) and sets a W-phase current detection timing 207 as an end point of W-phase current detection section width 206 after the shift processing (in other words, V-phase OFF timing).

If the current detection section width of reference value TSPini is ensured by the shift processing for the PWM signals as explained above, output of current detector 4 can be sampled as a phase current detection value after the delay time of switching elements 3a to 3f, the stabilization time of the circuit, and the like elapse. Motor control unit 6A can control a motor current at high accuracy.

Furthermore, in the present embodiment, current detection section width correction unit 24 of motor control unit 6A has a function of correcting reference value TSPini according to inverter voltage VINV and setting current detection section width TSPadj (TSPadj≥TSPini) according to inverter voltage VINV.

Then, PWM phase operation amount calculation unit 25 of motor control unit 6A implements the processing for shifting the phases of the PWM signals as illustrated in the lower part of FIG. 6 even when current detection section width TSPadj longer than reference value TSPini is ensured.

Specifically, when U-phase current detection section width 201 and W-phase current detection section width 202 are shorter than current detection section width TSPadj, PWM phase operation amount calculation unit 25 of motor control unit 6A calculates, as a U-phase PWM shift amount 209, a value obtained by subtracting U-phase current detection section width 201 from current detection section width TSPadj and calculates, as a W-phase PWM shift amount 210, a value obtained by subtracting W-phase current detection section width 202 from current detection section width TSPadj.

Then, switch timing setting unit 20 of motor control unit 6A implements shift processing for applying U-phase PWM shift amount 209 to U-phase ON timing and U-phase OFF timing and delaying a phase of a U-phase PWM signal by U-phase PWM shift amount 209 and, similarly, implements shift processing for applying W-phase PWM shift amount 210 to W-Phase ON timing and W-phase OFF timing and advancing a phase of a W-phase PWM signal by W-phase PWM shift amount 210.

Switch timing setting unit 20 of motor control unit 6A equalizes, with the shift processing for the PWM signals explained above, a U-phase current detection section width 211 after the shift processing and a W-phase current detection section width 212 after the shift processing with current detection section width TSPadj.

Then, AD timing setting unit 21 of motor control unit 6A is capable of stably detecting U-phase current Iu by setting, with V-phase OFF timing set as a start point, a U-phase current detection timing 213 at any position between U-phase current detection section width 205 and U-phase current detection section width 211.

Similarly, AD timing setting unit 21 of motor control unit 6A is capable of stably detecting W-phase current Iw by setting, with W-phase OFF timing set as a start point, a W-phase current detection timing 214 at any position between W-phase current detection section width 206 and W-phase current detection section width 212.

Note that, in FIG. 6, a pattern for detecting a positive U-phase current and a negative W-phase current is illustrated as an example. However, it is evident that, for other phase current detection patterns, a necessary current detection section width can be ensured by shift processing for alternately shifting phases of PWM signals.

Subsequently, current detection section width TSPadj corrected according to inverter voltage VINV is explained.

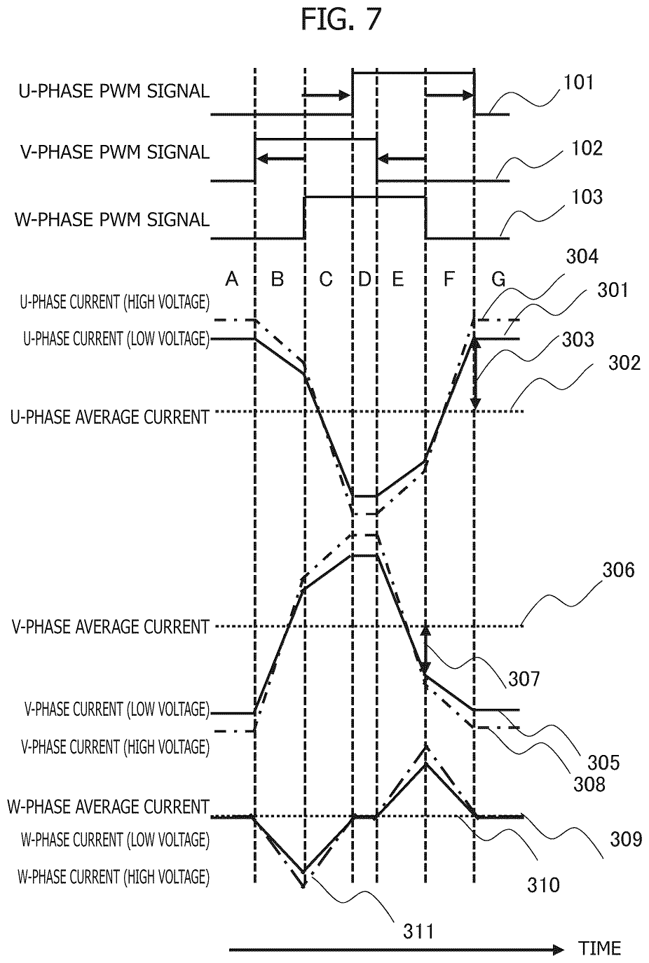

FIG. 7 is a time chart indicating that a change of three-phase currents in sections A to G of a PWM period is different depending on a level of inverter voltage VINV.

In section A in which U-phase PWM signal 101 is OFF, V-phase PWM signal 102 is OFF, and W-phase PWM signal 103 is OFF, phase currents recirculate in switching elements of the lower arm of inverter circuit 3 and motor 2.

At this time, since the voltages of the three phases are equal and the voltages converted into a d axis and a q axis are zero, the phase currents hardly change.

In section B in which U-phase PWM signal 101 is OFF, V-phase PWM signal 102 is ON, and W-phase PWM signal 103 is OFF, an electric current changes to flow from the V phase to the U phase and the W phase, a V-phase current 305 increases, and a U-phase current 301 and a W-phase current 309 decrease.

In section C in which U-phase PWM signal 101 is OFF, V-phase PWM signal 102 is ON, and W-phase PWM signal 103 is ON, an electric current changes to flow from the V phase and the W phase to the U phase, V-phase current 305 and W-phase current 309 increase, and U-phase current 301 decreases.

The absolute value of a gradient of the current change in this section C decreases compared with the absolute value in section B in V-phase current 305, increases compared with the absolute value in section B in U-phase current 301, and is the same as the absolute value in section B in W-phase current 309.

In section D in which U-phase PWM signal 101 is ON, V-phase PWM signal 102 is ON, and W-phase PWM signal 103 is ON, phase currents recirculate in the switching elements of the upper arm of inverter circuit 3 and motor 2 and hardly change as in section A.

In section E in which U-phase PWM signal 101 is ON, V-phase PWM signal 102 is OFF, and W-phase PWM signal 103 is ON, an electric current changes to flow from the U phase and the W phase to the V phase, V-phase current 305 decreases and U-phase current 301 and W-phase current 309 increase.

In section F in which U-phase PWM signal 101 is ON, V-phase PWM signal 102 is OFF, and W-phase PWM signal 103 is OFF, an electric current changes to flow from the U phase to the V phase and the W phase, V-phase current 305 and W-phase current 309 decrease, and U-phase current 301 increases.

The absolute value of a gradient of the current change in this section F decreases in V-phase current 305, increases in U-phase current 301, and is the same in W-phase current 309 compared with the absolute value in section E.

In section G in which U-phase PWM signal 101 is OFF, V-phase PWM signal 102 is OFF, and W-phase PWM signal 103 is OFF, phase currents recirculate in switching elements of the lower side of inverter circuit 3 and motor 2 as in section A.

As explained above, since the waveforms of the phase currents vibrate in sections A to G of the PWM period, a U-phase average current 302, a V-phase average current 306, and a W-phase average current 310 flowing on the average in the PWM period are regarded as phase currents actually flowing to the phases of motor 2.

Here, a V-phase current offset 307, which is the difference between the V-phase detection current and V-phase average current 306 at an end point of section E in which the V-phase current can be detected, is present and a U-phase current offset 303, which is the difference between the U-phase detection current and U-phase average current 302 at an end point of section F in which the U-phase current can be detected, is present.

That is, when electric currents flowing to shunt resistor 4A, which is a DC bus resistor, in the current detection sections are detected, the currents are values offset from an average current of the electric currents actually flowing to the phases.

For this reason, when electric currents flowing to shunt resistor 4A in the current detection sections are detected as phase currents, it is necessary to correct offsets of detection currents with a method of, for example, measuring and storing the offset values in advance and calculate an average current of electric currents actually flowing to the phases from the electric currents detected in the current detection sections.

For example, when all of three-phase command duty ratios DUu*, DUv*, and DUw* are the same value, the average current in the phases is zero. However, since a phase current detected in an individual current detection section is a value offset from the average current, this value can be stored as an offset value.

When a U-phase current waveform 304 in the case in which inverter voltage VINV is a high voltage and a U-phase current waveform 301 in the case in which inverter voltage VINV is a low voltage are compared, a gradient of an electric current changing in current detectable sections B, C, E, and F is greater in U-phase current waveform 304 at a high voltage than in U-phase current waveform 301 at a low voltage, and the current change is steep.

For that reason, if inverter voltage VINV increases or decreases, a V-phase current offset 307 and a U-phase current offset 303 also increase or decrease.

Therefore, when an offset correction value fixed irrespective of inverter voltage VINV is used to correct the detection current, if inverter voltage VINV changes, deviation occurs between an actual offset amount and the offset correction value used for the correction of the detection current.

Then, when the motor control is continued in a state in which a detection current used for the motor control deviates from an actual current actually flowing to motor 2, the actual current flowing to motor 2 deviates from a command current and motor torque changes.

For this reason, in order to prevent the motor torque from changing because of the increase or decrease of inverter voltage VINV, it is necessary to cope with the actual offset amount that changes according to inverter voltage VINV.

However, in order to effectively suppress the change in the motor torque by changing the offset correction value used for the correction of the current detection value according to inverter voltage VINV, the detection resolution of current detector 4 must be sufficient.

For example, if the resolution of current detection is insufficient in an electric power steering device including motor 2, a change for one unit of current detection resolution causes fluctuation in motor torque and such fluctuation in the motor torque gives discomfort to a driver through a steering wheel as a steering feel change.

In general, a range of a measurable electric current and current detection resolution are tradeoffs.

For this reason, in order to increase the detection resolution while ensuring a range of a measurable phase current, it is necessary to perform switching processing for the detection resolution for, for example, setting the detection resolution high in a region where the electric current is small and setting the detection resolution low in a region where the electric current is large.

However, in order to switch the current detection resolution, addition of a detection circuit, a change of software, and the like are necessary and system costs increase.

Thus, instead of changing the offset correction value for correcting the detection current in response to the increase or decrease in inverter voltage VINV, motor control unit 6A in the present embodiment is configured to adjust the offset amount, which occurs in the detection current, through correction of the current detection section width and the current detection timing, so that a fixed offset correction value may be applied even if inverter voltage VINV increases or decreases.

With the configuration explained above, measures against the offset amount that changes according to inverter voltage VINV do not depend on the current detection resolution but depend on the resolution of the current detection section width and the current detection timing and motor inductance.

The resolution of the current detection section width and the current detection timing is determined by a clock frequency for counting a PWM period. The clock frequency is different depending on microcomputer 61 and an oscillator.

For example, in motor control of the electric power steering device, if it is assumed that the current detection resolution is approximately 0.1 A, the clock frequency for counting the PWM period is 80 MHz, and the motor inductance is 70 uH, since a change amount of the electric current per one clock cycle is approximately 0.001 A, the adjustment of the current detection section width and the current detection timing is equivalent to increasing the resolution of the current detection 100 times.

On the other hand, since it is necessary to reduce a current measurement range to 1/100 in order to increase the current detection resolution 100 times, it is difficult to implement the increase in the current detection resolution.

For example, in the electric power steering device, it is necessary to measure an electric current in a range of approximately ±100 A in motor control.

Even if the resolution of the AD converter used when detecting an electric current with microcomputer 61 can be changed, it is necessary to increase the resolution by seven bits, which is 128 times, leading to a cost increase.

There is also a problem in that, although the current detection resolution can be increased, there is a limit in the resolution of a voltage applied to motor 2.

In contrast, when the offset amount that occurs in the detection current is adjusted by correction of the current detection section width and the current detection timing, it is unnecessary to switch the current resolution with hardware or software. It is possible to achieve both of the current detection range and the current resolution.

Since the phase currents can be adjusted more finely than the phase current detection resolution, it is possible to improve the adjustment of the motor torque and the adjustment of the steering feeling and improve the adjustment of the offset amount that changes according to inverter voltage VINV.

Since the offset of the detection current can be adjusted more finely than the phase current detection resolution and does not rely on the phase current detection resolution, it is possible to reduce costs by reducing the phase current detection resolution.

Furthermore, it is unnecessary to change the offset correction value according to inverter voltage VINV, and it is unnecessary to measure gradients of inverter voltage VINV and the offset amount in advance.

In the following explanation, a fluctuation amount of an electric current in the current detection section is calculated.

For the dq axes, when a d-axis voltage is represented as Vd, a q-axis voltage is represented as Vq, resistance is represented as R, a d-axis current is represented as Id, a q-axis current is represented as Iq, d-axis inductance is represented as Ld, q-axis inductance is represented as Lq, motor rotating speed is represented as ω, and an interlinkage flux is represented as φ, the following circuit equation of Equation 1 holds:

$$Vd = RId + L d I d / d t - ω LqIq \qquad [ Equation 1 ]$$

$$Vq = RIq + LdIq / dt + ω LdId + ω φ$$

Solving the circuit equation of Equation 1 for dId/dt and dIq/dt, leads to Equation 2.

$$dId / dt = ( V - Rid + ω LqIq ) / L \qquad [ Equation 2 ]$$

$$dIq / dt = ( V - Riq - ω LdId - ω φ ) / L$$

Here, if a voltage drop due to a phase current and phase resistance and rotating speed are sufficiently and negligibly low, ω can be regarded as ω=0 and RI can be regarded as RI=0. Equation 2 can be approximated like Equation 3.

$$d I d / d t = V d / Ld \qquad [ Equation 3 ]$$

$$dIq / dt = Vq / Lq$$

Since current fluctuation amounts ΔId and ΔIq in a current detection section TSP are products of gradients and times, the current fluctuation amounts ΔId and ΔIq can be calculated according to Equation 4.

$$Δ I d = d I d / dt * TSP = Vd * TSP / Ld \qquad [ Equation 4 ]$$

$$Δ Iq = d I q / dt * TSP = Vq * TSP / Lq$$

That is, current fluctuation amounts ΔId and ΔIq in current detection section TSP is proportional to the width of the current detection section and inverter voltage VINV.

Fluctuation amounts ΔIu, ΔIv, and ΔIw of the phases can be calculated by two-phase to three-phase conversion from current fluctuation amounts ΔId and ΔIq in the dq axes. The approximation explained above holds when current detection section TSP is sufficiently short.

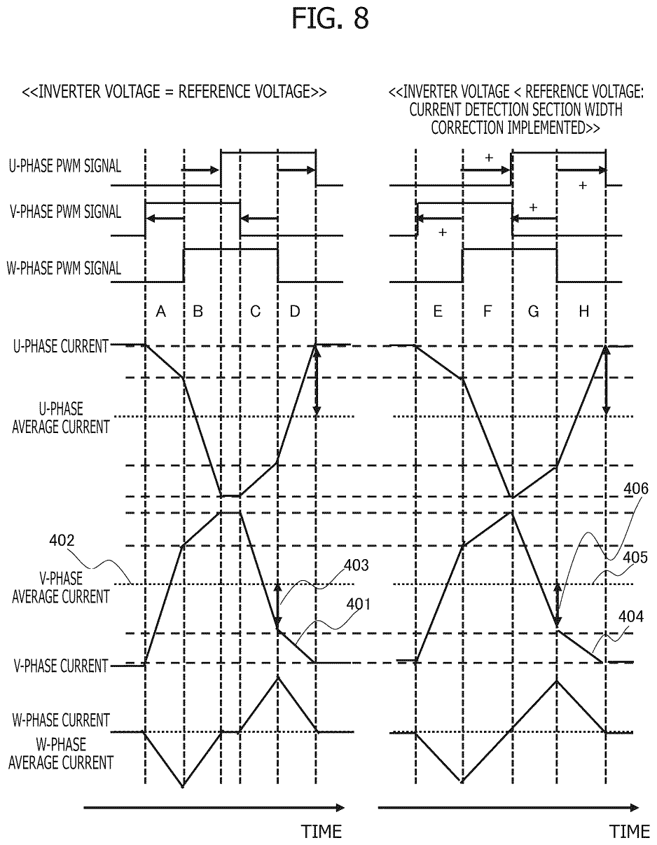

FIG. 8 is a time chart illustrating processing for, when inverter voltage VINV changes, correcting the current detection section width to thereby fix an offset amount that occurs in a detection current, that is, a function of current detection section width correction unit 24.

The left side of FIG. 8 illustrates the phase currents and the current detection section width at the time when inverter voltage VINV is a reference voltage. The right side of FIG. 8 illustrates the phase currents and the current detection section width at the time when inverter voltage VINV is a voltage lower than the reference voltage.

When inverter voltage VINV is equal to the reference voltage (see the left side of FIG. 8), an offset amount 403, which is the difference between a V-phase detection current 401 and a V-phase average current 402 detected at an end point of section C in which a V-phase current can be detected, occurs.

Similarly, when inverter voltage VINV is lower than the reference voltage (see the right side of FIG. 8), an offset amount 406, which is the difference between a V-phase detection current 404 and a V-phase average current 405 detected at an end point of section G in which a V-phase current can be detected, occurs.

Here, width obtained by correcting the width of section C (that is, reference value TSPini of the current detection section width) according to inverter voltage VINV is set as the width of section G such that offset amount 403 and offset amount 406 are equal; in other words, an offset amount is held constant even if inverter voltage VINV changes from the reference voltage.

Note that the same applies to section D and section H in which a U-phase current can be detected. The width of section H at the time when inverter voltage VINV is lower than the reference voltage is adjusted based on the width of section D at the time when inverter voltage VINV is the reference voltage such that the offset amount does not change from the offset amount at the time of the reference voltage even if inverter voltage VINV is lower than the reference voltage.

That is, current detection section width correction unit 24 sets the current detection section width longer than reference value TSPini as inverter voltage VINV is lower than the reference voltage to prevent the offset amount from changing even if inverter voltage VINV is lower than the reference voltage.

If inverter voltage VINV is different, a gradient of fluctuation that occurs in a detection current waveform in the current detection section is different. If the gradient is different, a change amount of a detection current in the current detection section changes and an offset amount, which is the difference between the detection current and an average current, changes.

Here, an offset amount ΔOS is represented by Equation 5 based on inverter voltage VINV, current detection section width TSP, and inductance L.

$$Δ OS = VINV * TSP / L \qquad [ Equation 5 ]$$

Thus, when inverter voltage VINV changes from the reference voltage, current detection section width correction unit 24 changes current detection section width TSP based on a relation of Equation 5 to suppress the change in offset amount ΔOS.

Specifically, an inverter reference voltage VINV0, an inverter detection voltage VINVx, current detection section width reference value TSPini, and current detection section width TSPadj after correction satisfy Equation 6. A formula for calculating current detection section width TSPadj is like Equation 7.

$$VINV 0 * TSPini = VINVx * TSPadj \qquad [ Equation 6 ]$$

$$TSPadj = TSPini * VINV 0 / VINVx \qquad [ Equation 7 ]$$

Therefore, current detection section width correction unit 24 can calculate, based on Equation 7, at inverter detection voltage VINVx at that time, current detection section width TSPadj in which an offset amount is the same as an offset amount that occurs at the time of inverter reference voltage VINV0.

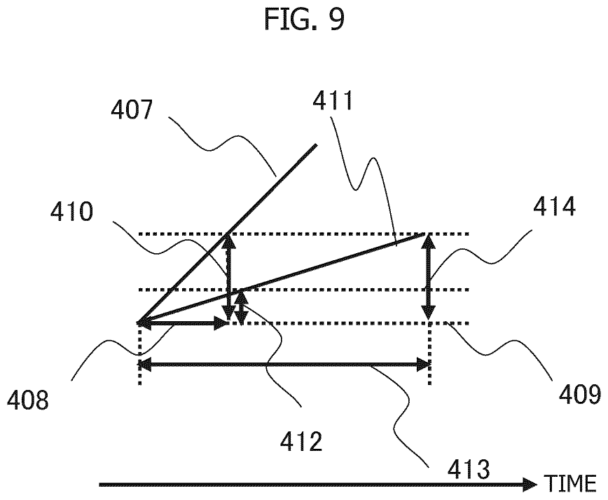

FIG. 9 is a diagram schematically indicating that current detection section width TSPadj is calculated based on Equation 7.

An offset 410, which is the difference between a value after elapse of a fixed time 408 and a value 409 before the elapse of the fixed time on a straight line 407 having a gradient greater than the gradient of a straight line 411, is greater than an offset 412, which is the difference between a value after the elapse of fixed time 408 and value 409 before the elapse of the fixed time on straight line 411 having a gradient less than the gradient of straight line 407.

For this reason, by allowing a fixed time 413 corrected to equalize offset 412 of straight line 411 having the relatively small gradient with offset 410 of straight line 407 having the relatively large gradient to pass, for straight line 411 having the small gradient, it is possible to obtain an offset 414 equal to offset 410 of straight line 407 having the large gradient.

As explained above, even if inverter voltage VINV fluctuates, by correcting the current detection section width, it is possible to fix the offset amount that occurs in the detection current.

Note that if the current detection section width increases at the time of the same inverter voltage VINV, the amplitude of the three-phase currents in one period of PWM increases and power consumption and electromagnetic noise increase.

When the correction of the current detection section width corresponding to inverter voltage VINV is not applied, power consumption and electromagnetic noise decrease when inverter voltage VINV is a low voltage compared with those when inverter voltage VINV is a high voltage. However, even if the correction of the current detection section width corresponding to inverter voltage VINV is applied, when the high voltage is set as a reference, power consumption and electromagnetic noise are not larger when inverter voltage VINV is the low voltage than when inverter voltage VINV is the high voltage.

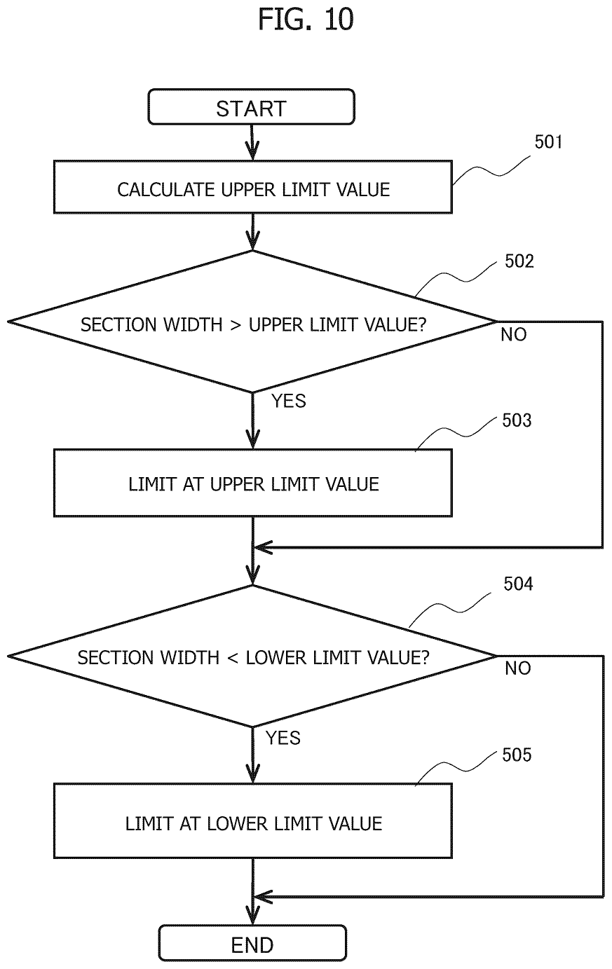

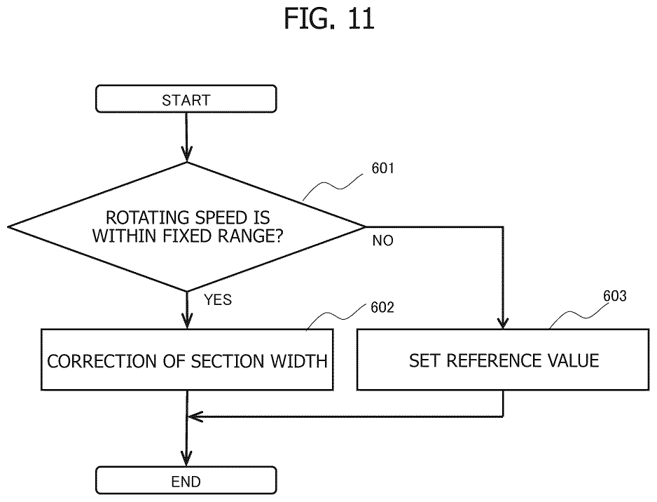

When the rotating speed of motor 2 increases, since a command duty ratio in PWM control is greater, a margin for ensuring a current detection section width at least necessary for current detection decreases. It is likely that a current detection rate is deteriorated by applying the correction of the current detection section width corresponding to inverter voltage VINV. However, the deterioration in the current detection rate can be prevented by implementing processing illustrated in FIG. 10 and FIG. 11 explained below.

If an offset occurs in the detection current, an actually flowing electric current deviates from the detection current due to the offset.

By using such a characteristic and adjusting the offset amount, it is possible to adjust the actually flowing electric current.

Compared with the case in which the offset correction value is changed in units of current detection resolution, when the occurring offset amount is changed in resolution units by the correction of the current detection section width and the current detection timing, it is possible to adjust the actually flowing current more finely than the current detection resolution.

When inverter voltage VINV, the current command, and the resolution of the detection current are set as input value INP, current detection section width correction unit 24 calculates current detection section width TSPadj to generate, as an offset amount ΔOSadd, a value obtained by subtracting, from the resolution of the detection current, the remainder obtained by dividing the current command by the resolution of the detection current.

That is, current detection section width correction unit 24 calculates current detection section width TSPadj according to Equation 8.

$$TSPadj = TSPini + Δ OSadd * L / VINV \qquad [ Equation 8 ]$$

By adjusting the offset amount with the correction of the current detection section width to be equal to an excessive or insufficient amount at the resolution of the detection current in the current command, it is possible to control the actually flowing current.

FIG. 10 is a flowchart illustrating limitation processing for current detection section width TSPadj executed by motor control unit 6A.

In step S501, motor control unit 6A calculates an upper limit value TSPul of current detection section width TSPadj based on a command duty ratio.

Subsequently, in step S502, motor control unit 6A determines whether current detection section width TSPadj exceeds upper limit value TSPul.

If current detection section width TSPadj exceeds upper limit value TSPul, motor control unit 6A proceeds to step S503. If current detection section width TSPadj does not exceed upper limit value TSPul, motor control unit 6A proceeds to step S504, bypassing step S503.

In step S503, motor control unit 6A limits current detection section width TSPadj at upper limit value TSPul.

That is, in step S502, motor control unit 6A sets upper limit value TSPul to current detection section width TSPadj to limit current detection section width TSPadj within a range not exceeding upper limit value TSPul.

Accordingly, it is possible to prevent an abnormal misuse of current detection section width TSPadj.

In step S504, motor control unit 6A determines whether current detection section width TSPadj is shorter than a predetermined lower limit value TSPll.

Lower limit value TSPll is a value determined in advance considering a delay time of switching elements 3a to 3f, a stabilization time of a circuit, an AD conversion time, and the like and stored in a nonvolatile memory such as the ROM of microcomputer 61 as a setting value.

If current detection section width TSPadj is shorter than lower limit value TSPll, motor control unit 6A proceeds to step S505. If current detection section width TSPadj is not shorter than lower limit value TSPll, motor control unit 6A directly ends this routine.

In step S505, motor control unit 6A sets lower limit value TSPll as current detection section width TSPadj to limit current detection section width TSPadj within a range not lower than lower limit value TSPll.

Accordingly, it is possible to avoid, for example, the effects of vibration that occur in an electric current detected in a current detection section having a width shorter than lower limit value TSPll.

As explained above, motor control unit 6A implements the processing illustrated in the flowchart of FIG. 10 to limit current detection section width TSPadj to a value within a region between upper limit value TSPul and lower limit value TSPll.

FIG. 11 is a flowchart illustrating arithmetic processing for current detection section width TSPadj executed by motor control unit 6A and illustrates processing for implementing correction of a current detection section width corresponding to inverter voltage VINV limitedly when a predetermined condition is satisfied, specifically, when rotating speed is within a predetermined range.

In step S601, motor control unit 6A determines whether motor rotating speed is within a predetermined low rotating speed range, in other words, whether the motor rotating speed is lower than a predetermined threshold.

When the motor rotating speed is within the predetermined low rotating speed range, that is, when the rotating speed of motor 2 is lower than the threshold, motor control unit 6A proceeds to step S602.

In step S602, motor control unit 6A corrects reference value TSPini according to inverter voltage VINV to calculate current detection section width TSPadj.

On the other hand, when the motor rotating speed is outside the predetermined low rotating speed range, that is, the rotating speed of motor 2 exceeds the threshold, motor control unit 6A proceeds to step S603.

In step S603, motor control unit 6A directly outputs reference value TSPini as current detection section width TSPadj.

The low rotating speed range for implementing the correction of current detection section width TSPadj corresponding to inverter voltage VINV explained above is, for example, when motor 2 is a motor that generates a steering force in the electric power steering device, set based on a region where a driver can feel a change in motor torque via a steering wheel.

That is, the correction of current detection section width TSPadj corresponding to inverter voltage VINV is implemented limitedly to the region where the change in the motor torque is felt. Fluctuation in the motor torque felt by the driver is reduced.

Accordingly, in a region in which it is difficult to feel the effect of reducing the change in the motor torque, the correction of current detection section width TSPadj corresponding to inverter voltage VINV is prevented from being uselessly implemented. A calculation load of motor control unit 6A, that is, microcomputer 61, can be reduced.

Note that, in the arithmetic processing illustrated in the flowchart of FIG. 11, motor control unit 6A adopts the rotating speed of motor 2 as a condition for determining whether to implement the correction of current detection section width TSPadj corresponding to inverter voltage VINV. However, the condition is not limited to the condition of the rotating speed.

For example, motor control unit 6A can switch, according to a torque command or a modulation ratio of the PWM instead of the condition of the rotating speed, whether to implement the correction of current detection section width TSPadj corresponding to inverter voltage VINV.

Motor control unit 6A can switch, according to a combination of a plurality of conditions among the rotating speed, the torque command, and the modulation ratio, whether to implement the correction of current detection section width TSPadj corresponding to inverter voltage VINV.

Here, motor control unit 6A does not implement the correction of current detection section width TSPadj corresponding to inverter voltage VINV to switch the implementation and a stop of the correction corresponding to inverter voltage VINV based on a condition of the torque command or the modulation ratio under which a torque change exceeding an allowable level occurs.

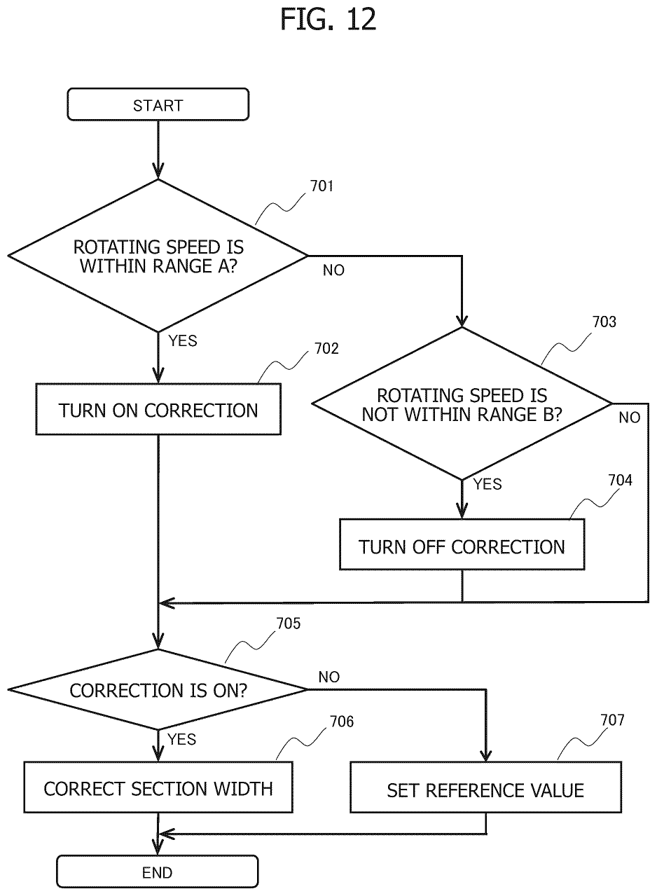

FIG. 12 is a flowchart illustrating another aspect of the arithmetic processing for current detection section width TSPadj executed by motor control unit 6A and illustrates a case in which a hysteresis characteristic is given to the processing for switching whether to implement the correction of current detection section width TSPadj corresponding to inverter voltage VINV.

In step S701, motor control unit 6A determines whether the motor rotating speed is within a first rotating speed range, in other words, whether the motor rotating speed is lower than a first threshold.

When the motor rotating speed is within the first rotating speed range, motor control unit 6A proceeds to step S702, performs setting for commanding the implementation of the correction of current detection section width TSPadj corresponding to inverter voltage VINV, and thereafter proceeds to step S705.

On the other hand, when the motor rotating speed is not within the first rotation speed range, motor control unit 6A proceeds to step S703.

In step S703, motor control unit 6A determines whether the motor rotating speed is within a predetermined second rotating speed range, in other words, whether the motor rotating speed is lower than a second threshold (the second threshold>the first threshold).

When the motor rotating speed is not within the predetermined second rotating speed range, that is, when the motor rotating speed is equal to or higher than the second threshold, motor control unit 6A proceeds to step S704.

In step S704, motor control unit 6A performs setting for cancelling an implementation command for the correction of current detection section width TSPadj corresponding to inverter voltage VINV.

On the other hand, when the motor rotating speed is lower than the second threshold, motor control unit 6A proceeds to step S705 bypassing step S704.

In step S705, motor control unit 6A determines whether the implementation command for the correction of current detection section width TSPadj corresponding to the inverter voltage VINV is set.

When the implementation command is set, motor control unit 6A proceeds to step S706 and implements the correction of current detection section width TSPadj corresponding to inverter voltage VINV.

On the other hand, when the implementation command is cancelled, motor control unit 6A proceeds to step S707 and directly outputs reference value TSPini as current detection section width TSPadj without implementing the correction corresponding to inverter voltage VINV.

That is, when the motor rotating speed is lower than the first threshold, motor control unit 6A starts the correction of current detection section width TSPadj corresponding to inverter voltage VINV but, thereafter, continues the correction processing even if the motor rotating speed rises to the first threshold or higher, and stops the correction processing for the first time when the motor rotating speed is equal to or higher than the second threshold which is higher than the first threshold.

According to such a hysteresis characteristic, when the motor rotating speed fluctuates near the first threshold, the implementation and the stop of the correction are prevented from being repeated, and stability of the correction control is improved.

Subsequently, a configuration for, in the correction processing for current detection section width TSPadj corresponding to inverter voltage VINV, reducing vibration of motor torque due to a noise component that occurs in a detection value of inverter voltage VINV is explained.

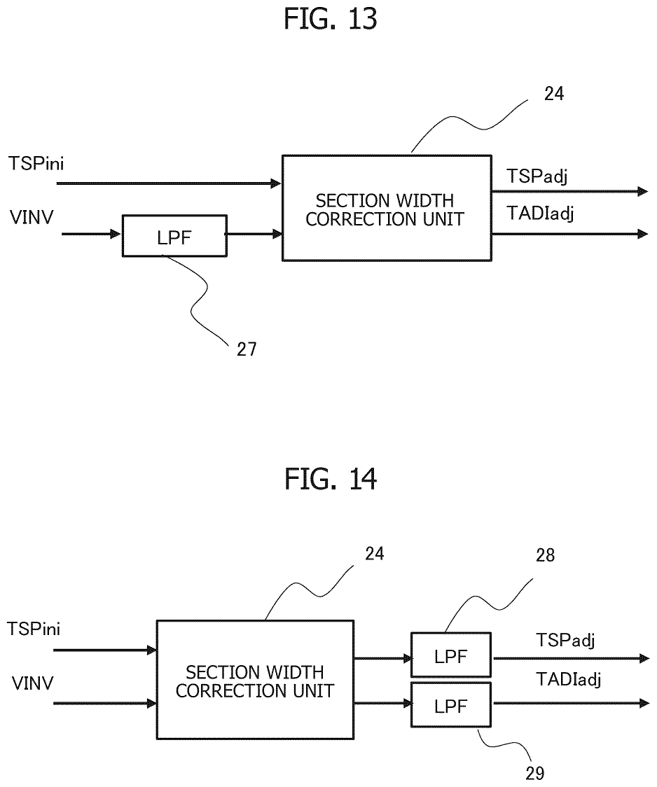

FIG. 13 illustrates a configuration in which a signal of inverter voltage VINV acquired by current detection section width correction unit 24 is a signal of inverter voltage VINV in which a noise component (that is, a high-frequency component) is removed by a digital low-pass filter 27, in other words, a signal of inverter voltage VINV that has passed through digital low-pass filter 27.

In a configuration illustrated in FIG. 14, a digital low-pass filter 28 removes a noise component from a signal of current detection section width TSPadj output by the current detection section width correction unit 24 and, similarly, a digital low-pass filter 29 removes a noise component from a signal of current detection timing correction value TADIadj output by current detection section width correction unit 24.

PWM phase operation amount calculation unit 25 acquires a signal of current detection section width TSPadj having passed through digital low-pass filter 28. AD timing setting unit 21 acquires a signal of current detection timing correction value TADIadj that has passed through digital low-pass filter 29.

With the configurations illustrated in FIG. 13 and FIG. 14, motor torque is prevented from being vibrated by a noise component that occurs in a detection value of inverter voltage VINV.

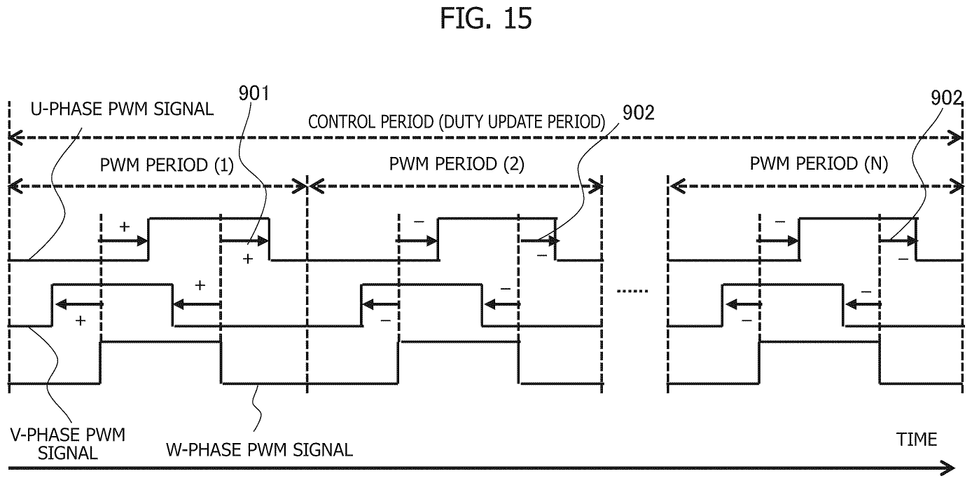

FIG. 15 is a time chart illustrating time diffusion processing for correction of current detection section width TSPadj corresponding to inverter voltage VINV.

The time diffusion processing illustrated in FIG. 15 is processing for detecting phase currents at a rate of once in a plurality of periods of PWM and reducing a shift amount of a phase of a PWM signal at a PWM period in which phase currents are not detected compared with the shift amount at a PWM period in which phase currents are detected. The plurality of PWM periods can be a control period for updating a duty ratio in the PWM.

In FIG. 15, a period at which three-phase command duty ratios DUu*, DUv*, and DUw* are updated is set as the control period. The control period includes N number of PWM periods from a first PWM period to an N-th PWM period.

At the first PWM period in the first place, the correction of current detection section width TSPadj corresponding to inverter voltage VINV is applied and detection of phase currents is performed at current detection section width TSPadj corrected according to inverter voltage VINV.

At the PWM periods from the second PWM period to the N-th PWM period, a section width obtained by subtracting, from reference value TSPini, a value obtained by dividing an increase correction amount of a section width, which is the difference between current detection section width TSPadj applied to the first PWM period and the reference TSPini, by “N−1” is set as a current detection section width. An average of the current detection section width at the control period is adjusted to reference value TSPini.

With such a configuration, it is possible to reduce a PWM period at which current detection section width TSPadj is increased to be longer than reference value TSPini, reduce fluctuating amplitude of three-phase currents as an average in the control period, and reduce an increase in power consumption and electromagnetic noise.

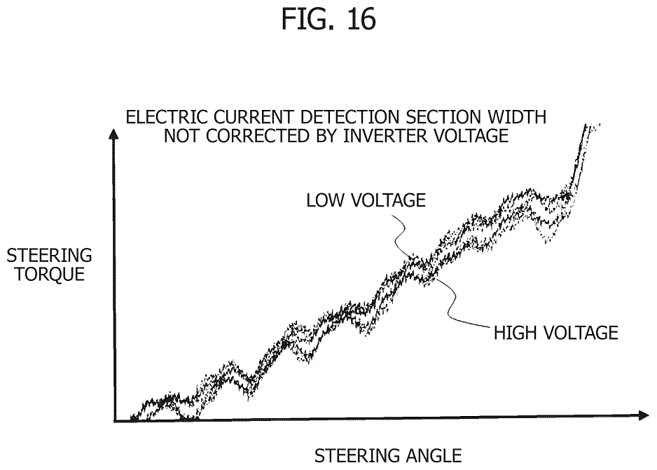

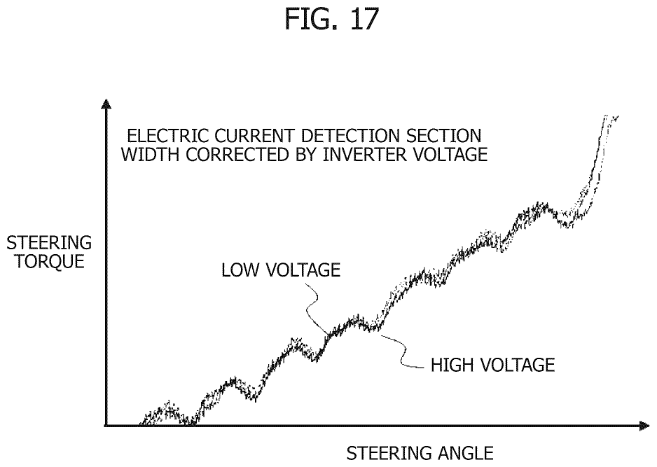

FIG. 16 and FIG. 17 are diagrams illustrating, when motor 2 is a motor that generates steering torque in an electric power steering device, for each level of inverter voltage VINV, a correlation between the steering torque generated by motor 2 and a steering angle.

FIG. 16 is a diagram illustrating a correlation between the steering torque and the steering angle in a state in which the correction of current detection section width TSPadj corresponding to inverter voltage VINV is not implemented and indicates that the steering torque generated by motor 2 shifts when inverter voltage VINV changes.

On the other hand, FIG. 17 is a diagram illustrating a correlation between the steering torque and the steering angle in a state in which the correction of current detection section width TSPadj corresponding to inverter voltage VINV is implemented and indicates that the steering torque at the same level is generated even if inverter voltage VINV changes.

That is, if the correction of current detection section width TSPadj corresponding to inverter voltage VINV is implemented, even if inverter voltage VINV changes, it is possible to calculate average currents (actual phase currents) of phases with high accuracy using a fixed offset correction value.

If the average currents (in other words, the actual phase currents) in the phases can be calculated with high accuracy, the accuracy of feedback control for performing a correction operation to bring phase currents to command currents increases. A change in the steering torque is prevented from occurring according to a change in inverter voltage VINV.

Furthermore, if the steering torque does not change even if inverter voltage VINV changes, the steering torque is not transmitted to the driver as a steering feeling change through the steering wheel. Discomfort is prevented from being given to the driver.

The technical ideas explained in the embodiment above can be used in combination as appropriate unless conflicts occur.

The content of the present invention is specifically explained with reference to the preferred embodiment. However, it is obvious that those skilled in the art can make various modifications based on the basic technical concept and the teachings of the present invention.

For example, when inverter voltage VINV is higher than the reference voltage, motor control unit 6A can implement processing for reducing the current detection section width to be shorter than the reference value.

Motor control unit 6A can implement detection of a phase current in a first phase among the three phases of motor 2 at a first PWM period and implement detection of a phase current in a second phase at a second PWM period next to the first PWM period.

The embodiment adopts a three-phase PWM scheme for performing pulse center arrangement using a double-edge triangular carrier as a carrier signal. However, in a three-phase PWM scheme using a single-edge triangular carrier as the carrier signal, it is also possible to apply the change in the current detection section width corresponding to inverter voltage VINV and the phase shift processing for the PWM signal for ensuring the current detection section width.

Current detector 4 explained above is a current sensor of a resistance detection type using shunt resistor 4A. However, a current sensor of a magnetic field detection type can be adopted as a current detector.

### REFERENCE SYMBOL LIST

1 Motor control system
2 Motor
3 Inverter circuit
4 Current detector
4A Shunt resistor
5 Inverter voltage detector
6 Motor control device
6A Motor control unit
6B Switching signal generation unit
6C AD conversion unit
7 DC power supply
20 Switch timing setting unit
21 AD timing setting unit
24 Current detection section width correction unit
25 PWM phase operation amount calculation unit
61 Microcomputer (Control unit)

1.-11. (canceled)

12. A motor control device for controlling a motor, the motor control device comprising:
a control unit, wherein the control unit:
acquires an output signal of a current detector that detects an electric current flowing between an inverter driven by a PWM signal and a DC power supply of the inverter;
samples the output signal of the current detector in a current detection section corresponding to a combination of ON and OFF of the PWM signal and detects phase currents of the motor;
controls the motor via the inverter based on the detected phase currents;
acquires a signal concerning a voltage of the DC power supply;
changes length of the current detection section based on the voltage of the DC power supply, and
sets the length of the current detection section to be longer as the voltage of the DC power supply is lower.

13. The motor control device according to claim 12, wherein the current detection section is a section from timing when the combination of ON and OFF of the PWM signal is switched until the output signal of the current detector is sampled.

14. The motor control device according to claim 12, wherein the control unit shifts phases of the PWM signals from one to another to ensure the length of the current detection section.

15. The motor control device according to claim 14, wherein the control unit:
detects the phase currents at a rate of once in a plurality of periods of a PWM control period; and
at the PWM control period in which the phase currents are not detected, reduces a shift amount of the PWM signal compared with the shift amount at the PWM control period in which the phase currents are detected.

16. The motor control device according to claim 15, wherein the control unit sets the plurality of periods as periods in which a duty ratio in PWM is changed.

17. The motor control device according to claim 12, wherein the control unit changes the length of the current detection section within a region between an upper limit value and a lower limit value.

18. The motor control device according to claim 12, wherein, when rotating speed of the motor is within a predetermined range, the control unit changes the length of the current detection section based on the voltage of the DC power supply.

19. A motor control device for controlling a motor, the motor control device comprising:
a control unit, wherein the control unit:
acquires an output signal of a current detector that detects an electric current flowing between an inverter driven by a PWM signal and a DC power supply of the inverter;
samples the output signal of the current detector at predetermined timing and detects phase currents of the motor;
controls the motor via the inverter based on the detected phase currents;
acquires a signal concerning a voltage of the DC power supply; and
increases an amount of shifting phases of the PWM signal from one to another as the voltage of the DC power supply decreases.

20. A motor control method executed by a control unit, the motor control method comprising:
acquiring an output signal of a current detector that detects an electric current flowing between an inverter driven by a PWM signal and a DC power supply of the inverter;
sampling the output signal of the current detector in a current detection section corresponding to a combination of ON and OFF of the PWM signal and detecting phase currents of a motor;
controlling the motor via the inverter based on the detected phase currents;
acquiring a signal concerning a voltage of the DC power supply;
changing length of the current detection section based on the voltage of the DC power supply, and
sets the length of the current detection section to be longer as the voltage of the DC power supply is lower.

21. A motor control system comprising:
a motor;
an inverter driven by a PWM signal;
a current detector that detects an electric current flowing between the inverter and a DC power supply of the inverter; and
a control unit that:
acquires an output signal of the current detector;
samples the output signal of the current detector in a current detection section corresponding to a combination of ON and OFF of the PWM signal and detects phase currents of the motor;
controls the motor via the inverter based on the detected phase currents;
acquires a signal concerning a voltage of the DC power supply;
changes length of the current detection section based on the voltage of the DC power supply, and
sets the length of the current detection section to be longer as the voltage of the DC power supply is lower.
